(19) United States
(12) Patent Application Publication
(10) Pub. No.: US 2007/0110244 A1
(43) Pub. Date: May 17, 2007

(54) Method, apparatus and system for enabling a secure wireless platform

(76) Inventors: Kapil Sood, Beaverton, OR (US); Jesse R. Walker, Portland, OR (US); Ned Smith, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/281,713

(22) Filed: Nov. 16, 2005

(51) Int. Cl. H04K 1/00

(52) U.S. Cl. 380/270

(57) ABSTRACT

A method, apparatus and system enable a secure wireless platform. Specifically, embodiments of the present invention may utilize a secure processing area to enforce security mechanisms on the wireless platform, thus isolating the security measures (e.g., security keys) from the host operating system on the wireless node.

### BACKGROUND

Wireless networks are proliferating at a rapid pace as computer users become increasingly mobile. Wireless networks offer users significant flexibility to “roam” across networks without being tied to a specific location. One downside of wireless networks, however, is that they typically face significant security issues. Since the connection is “wireless”, i.e., not physical, any party with a compatible wireless network interface may position themselves to inspect and/or intercept wireless packets. In other words, any third party hacker or attacker may, with relative ease, gain access to packets being transmitted across a wireless network, regardless of who the packets are actually destined for.

### BRIEF DESCRIPTION OF THE DRAWINGS

The present invention is illustrated by way of example and not limitation in the figures of the accompanying drawings in which like references indicate similar elements, and in which:

FIG. 1 illustrates a typical wireless network topology;

FIG. 2 illustrates conceptually the components in a typical wireless node;

FIG. 3 illustrates an example AMT environment;

FIG. 4 illustrates an example virtual machine host;

FIG. 5 illustrates conceptually the components of an embodiment of the present invention;

FIG. 6 illustrates conceptually the interaction between the components according to an embodiment of the present invention; and

FIG. 7 is a flow chart illustrating an embodiment of the present invention.

### DETAILED DESCRIPTION

Embodiments of the present invention provide a method, apparatus and system for enabling a secure wireless platform. More specifically, embodiments of the present invention provide a secure environment within which wireless platforms may process wireless protocol management and control frames; and, storage and access of security key material for enabling secure wireless protocols on wireless platforms. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

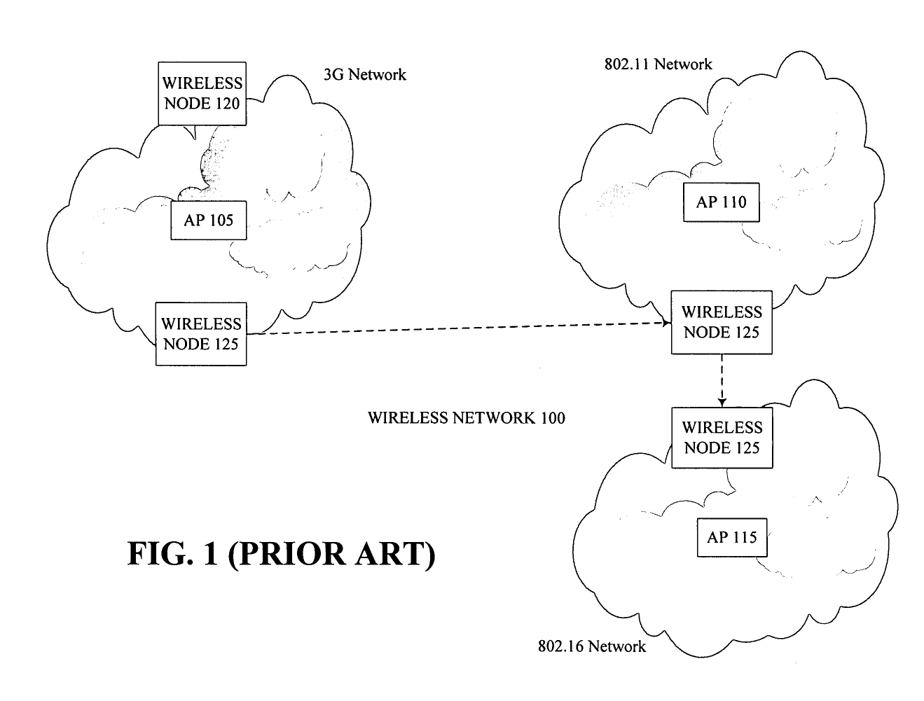

In order to facilitate understanding of embodiments of the present invention, FIG. 1 describes a typical wireless network topology. As illustrated in FIG. 1, Wireless Network 100 may comprise a collection of different types of networks (e.g., an 802.11 network, an 802.16 network and a “3G” network. 3G networks are well known to those of ordinary skill in the art and include networks that conform to the 3G International Telecommunications Union (“ITU”) specification for mobile communications technology. In alternate embodiments, Wireless Network 100 may comprise the same types of networks and/or a different combination of network types. Additionally, Wireless Network 100 may comprise any type of network architecture, including but are not limited to wireless local area networks (“WLANs”), wireless wide area networks (“WWANs”) including 3G networks, wireless metropolitan area networks (“WMANs”) and/or corporate intranets. As illustrated, Wireless Network 100 may include one or more access points or APs (illustrated conceptually as “AP 105”, “AP 110” and “AP 115” in FIG. 1 and referred to collectively as “APs”) and one or more end nodes (illustrated conceptually as “Wireless Node 120” and “Wireless Node 125” in FIG. 1 and referred to collectively as “Wireless Nodes”). It will be readily apparent to those of ordinary skill in the art that although only a handful of APs and nodes are illustrated, embodiments of the present invention are not so limited.

Wireless Nodes 120 and 125 may comprise any type of device that is capable of communicating wirelessly with other devices. Generally such devices may include personal computers, servers, laptops, portable handheld computers (e.g., personal digital assistants or “PDAs”), set-top boxes, intelligent appliances, wireless telephones, web tablets, wireless headsets, pagers, instant messaging devices, digital cameras, digital audio receivers, televisions and/or other devices that may receive and/or transmit information wirelessly (including hybrids and/or combinations of the aforementioned devices). APs are “entry points” that provide wireless nodes with access to Wireless Network 100. APs and the Wireless Nodes may communicate with one another using protocols and standards established by the IEEE for wireless communications. For example, some embodiments may conform to the IEEE 802.11 standard, while other embodiments may conform to IEEE 802.16 networks and/or wired networks like IEEE 802.3 Ethernet LANs.

It will be readily apparent to those of ordinary skill in the art that APs may comprise a standalone device and/or be incorporated as part of another network device such as a network bridge, router, or switch. Each AP typically has a predetermined range within which a wireless node may freely roam without interruption. Thus, for example, as illustrated, if Wireless Node 125 is initially within the predetermined range of AP 105 but thereafter moves out of that range, Wireless Node 125 may have to reestablish its wireless connection via a new entry point (e.g., AP 115 at its new location). When Wireless Nodes come within the range of APs, the Wireless Nodes and APs typically engage in a series of messages that are designed to initiate a communications session between the Wireless Node and the APs. The Wireless Nodes and APs may additionally engage in various exchanges designed to establish a secure link between the two points. Further details of these interactions are described in detail later in the specification.

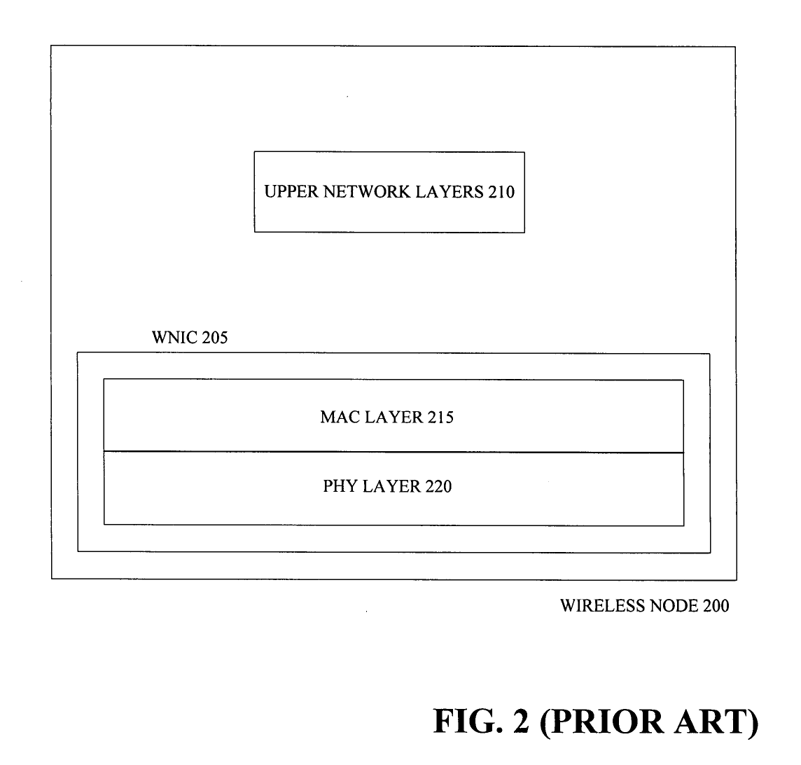

FIG. 2 illustrates conceptually various components that may be incorporated in a wireless device or node (“Wireless Node 200”). As illustrated, Wireless Node 200 may include a wireless network interface card (“WNIC 205”) and the components in Wireless Node 200 may include an upper network layer (collectively illustrated as Upper Network Layers 210”), a media access and control layer (“MAC 215”) and a physical layer (“PHY 220”). It will be readily apparent to those of ordinary skill in the art that various other components may additionally be incorporated into these nodes but are omitted in the illustration herein in order not to unnecessarily obscure embodiments of the present invention. It is well known in the art that MAC 215 is one of the sub-layers that make up the Data Link Layer of the Open Systems Interconnect (“OSI”) model. MAC 215 is responsible for moving data packets from the hardware to the network stack and out of the node. Similarly, PHY 220 refers to the physical layer in the OSI model, i.e. the layer that provides the hardware to send and receive data on a node. Upper Network Layers 210 reside “above” MAC 215 and typically include the application layer, the presentation layer, the session layer, the transport layer and the network layer.

Wireless transmissions typically include various types of frames, e.g., data frames, management frames and control frames. Data frames are used to transmit data while management frames are typically transmitted the same way as data frames but are not forwarded to Upper Network Layers 210 (i.e., management frames are used for MAC functionality). Control frames, on the other hand, are typically used to control access to the device (i.e., used for PHY interaction). Thus, collectively, management frames and control frames are responsible for establishing and maintaining the wireless connections. Hereafter, any reference to “management frames” shall include both management and control frames.

As previously described, Wireless Nodes and APs may engage in various exchanges designed to establish a secure link between the two points. A variety of encryption schemes may be utilized to enable secure wireless transmissions. These schemes, however, are typically only as secure as the host operating system (“OS”) on the wireless devices. In other words, regardless of the various encryption and/or other 802.11 security measures that may be implemented, the security measures themselves are nonetheless limited by the vulnerability of the WNIC driver (installed on the host OS) to various types of attacks. Thus, for example, although the IEEE 802.11 specification defines a “supplicant” to establish various security measures, this supplicant resides in the host OS and is nonetheless subject to attacks that may be levied at the OS.

As a result, wireless networks continue to be vulnerable to attacks that can significantly affect the security of the wireless sessions. The lack of protection for wireless frames, for example, leaves wireless network users open to “man in the middle” (“MITM”) attacks in which an attacker is able to read, insert and modify messages between two parties without either party knowing that the wireless connection between them has been compromised. Another type of attack comprises a “replay” technique wherein a message from a wireless node may be recoded by an unauthorized third party and then replayed at a later time to simulate a seemingly legitimate message and thereby gain access to the network.

According to an embodiment of the present invention, a secure wireless environment may be defined wherein MAC functionality is routed to an isolated and secure environment for processing. Security keys are also generated within this isolated environment, remote from, and inaccessible by, the host OS. In one embodiment, the generated security keys may additionally be stored in a location remote from and inaccessible by the host OS. More specifically, according to an embodiment of the invention, 802.11 control and management frames are routed via a secure environment while the data frames continue to be routed via the host. Both data and management frames may be encrypted by the network hardware, but in one embodiment, the management frames may also be encrypted within the secure partition. In all cases, the security keys typically used to protect the WLAN communication session are generated and stored within the hardware accessible only by the secure environment and never read by the host OS.

This isolated and secure environment may comprise a variety of different types of partitions, including an entirely separate hardware partition (e.g., utilizing Intel® Corporation's Active Management Technologies (“AMT”), “Manageability Engine” (“ME”), Platform Resource Layer (“PRL”) and/or other comparable or similar technologies) and/or a virtualized partition (e.g., a virtual machine in Intel® Corporation's Virtualization Technology (“VT”) scheme). It will be apparent to those of ordinary skill in the art that a virtualized host may also be used to implement AMT, ME and PRL technologies (as described in further detail below).

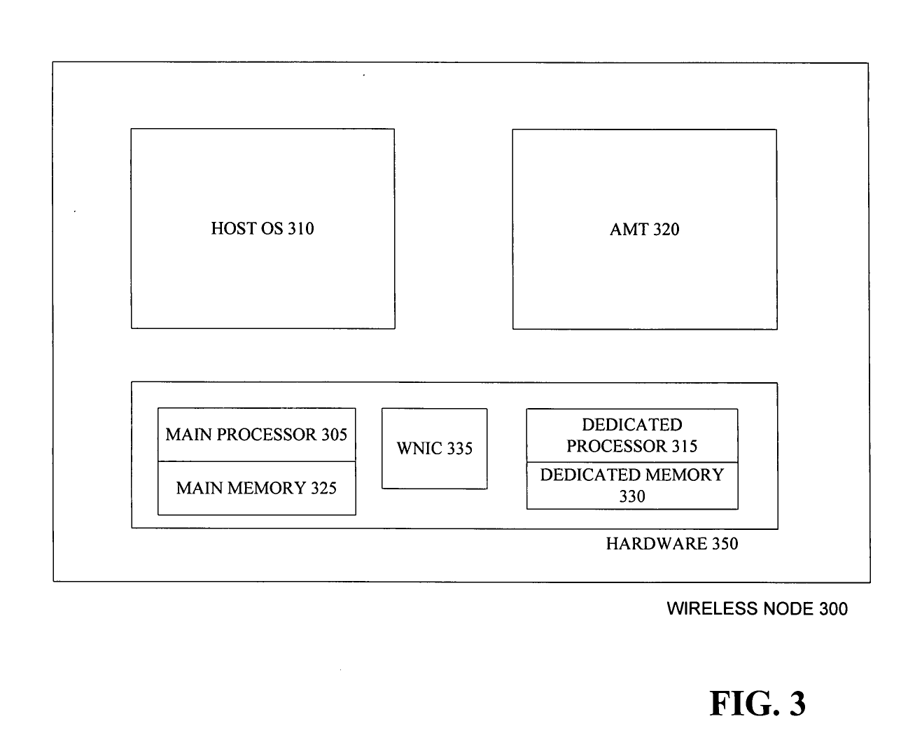

By way of example, FIG. 3 illustrates conceptually a typical AMT environment as implemented by Intel Corporation. It will be readily apparent to those of ordinary skill in the art that embodiments of the present invention may also be implemented in other similar and/or comparable implementations of AMT. Only the components pertinent to describing the AMT environment have been illustrated in order not to unnecessarily obscure embodiments of the present invention, but it will be readily apparent to those of ordinary skill in the art that additional components may be included without departing from the spirit of embodiments of the invention.

Thus, as illustrated in FIG. 3, a wireless device (“Wireless Device 300”) may include a host operating system (“Host OS 310”) and system hardware (“Hardware 350”). According to one embodiment, Hardware 350 may include two processors, one to perform typical processing tasks for Host OS 310 (“Main Processor 305”) while the other may be dedicated exclusively to managing the device via a dedicated partition (“Dedicated Processor 315” for “AMT 320”). Each processor may have associated resources on Wireless Device 300 and they may share one or more other resources. Thus, as illustrated in this example, Main Processor 305 and Dedicated Processor 310 may each have portions of memory dedicated to them (“Main Memory 325” and “Dedicated Memory 330” respectively) but they may share a wireless network interface card (“WNIC 335”).

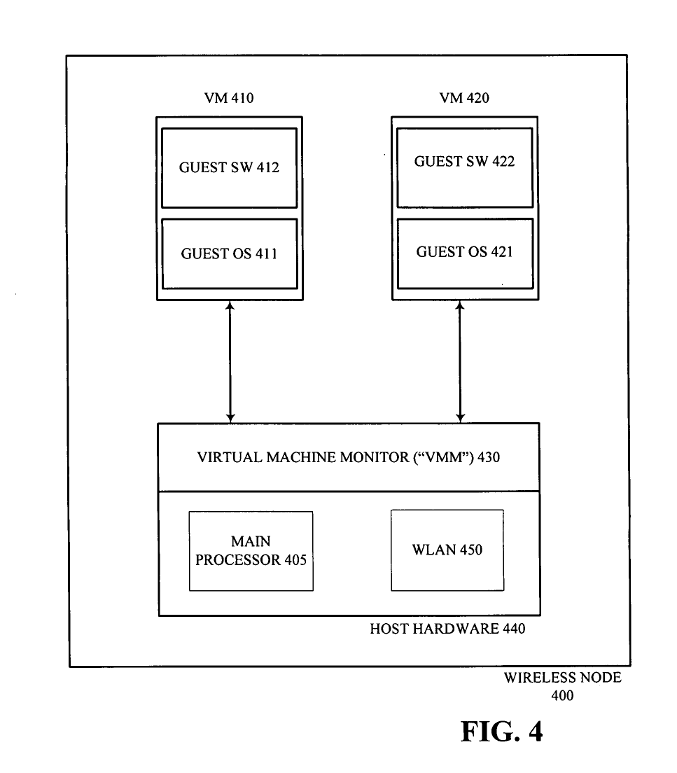

Similarly, as illustrated in FIG. 4, if the wireless device (“Wireless Device 400”) is virtualized, it may include only a single processor but a virtual machine monitor (“VMM 430”) on the device may present multiple abstractions and/or views of the device or host, such that the underlying hardware of the host appears as one or more independently operating virtual machines (“VMs”). VMM 430 may be implemented in software (e.g., as a standalone program and/or a component of a host operating system), hardware, firmware and/or any combination thereof. VMM 430 manages allocation of resources on the host and performs context switching as necessary to cycle between various VMs according to a round-robin or other predetermined scheme. It will be readily apparent to those of ordinary skill in the art that although only one processor is illustrated (“Main Processor 405”), embodiments of the present invention are not so limited and multiple processors may also be utilized within a virtualized environment.

Although only two VM partitions are illustrated (“VM 410” and “VM 420”, hereafter referred to collectively as “VMs”), these VMs are merely illustrative and additional virtual machines may be added to the host. VM 410 and VM 420 may function as self-contained platforms respectively, running their own “guest operating systems” (i.e., operating systems hosted by VMM 430, illustrated as “Guest OS 411” and “Guest OS 421” and hereafter referred to collectively as “Guest OS”) and other software (illustrated as “Guest Software 412” and “Guest Software 422” and hereafter referred to collectively as “Guest Software”).

Each Guest OS and/or Guest Software operates as if it were running on a dedicated computer rather than a virtual machine. That is, each Guest OS and/or Guest Software may expect to control various events and have access to hardware resources on Host 100. Within each VM, the Guest OS and/or Guest Software may behave as if they were, in effect, running on Wireless Device 400's physical hardware (“Host Hardware 140”, which may include a wireless Network Interface Card (“WLAN 450”)).

It will be readily apparent to those of ordinary skill in the art that a physical hardware partition with a dedicated processor (as illustrated in FIG. 3, for example) may provide a higher level of security than a virtualized partition (as illustrated in FIG. 4), but embodiments of the invention may be practiced in either environment and/or a combination of these environments to provide varying levels of security. It will also be readily apparent to those of ordinary skill in the art that an AMT, ME or PRL platform may be implemented within a virtualized environment. For example, VM 420 may be dedicated as an AMT partition on a host while VM 410 runs typical applications on the host. In this scenario, the host may or may not include multiple processors. If the host does include two processors, for example, VM 420 may be assigned Dedicated Processor 315 while VM 410 (and other VMs on the host) may share the resources of Main Processor 305. On the other hand, if the host includes only a single processor, the processor may serve both the VMs, but VM 420 may still be isolated from the other VMs on the host with the cooperation of VMM 430. For the purposes of simplicity, embodiments of the invention are described in an AMT environment, but embodiments of the invention are not so limited. Instead, any reference to AMT, a “partition”, a secure partition”, a “security partition” and/or a “management partition” shall include any physical and/or virtual partition (as described above).

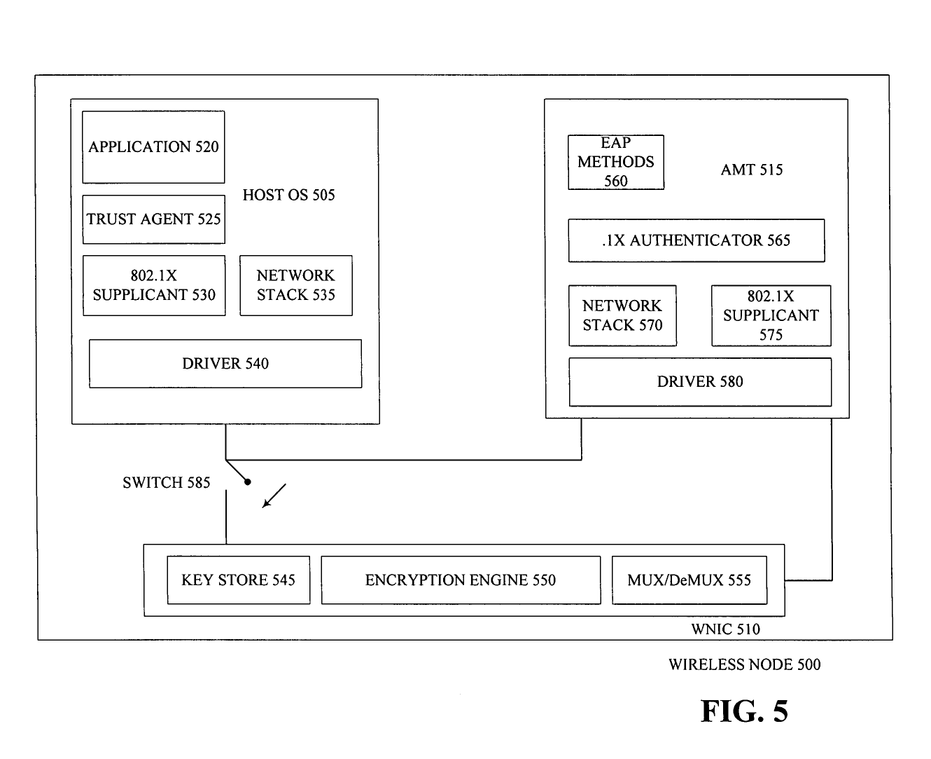

FIG. 5 illustrates an embodiment of the present invention. As illustrated, according to one embodiment of the present invention, a wireless device (“Wireless Node 500”) may include at least three logical components, namely a host operating system (“Host OS 505”), wireless local area network (“WLAN”) hardware/firmware (“WNIC 510”) and a dedicated partition such as an AMT (“AMT 515”). As previously stated, although the following description assumes an AMT, embodiments of the invention are not so limited. In one embodiment, AMT 515 may provide isolation from Host OS 505 (either via a physical separation, a virtual separation or a combination thereof) to enhance the security on the wireless platform.

Host OS 505 may remain unchanged and includes components typically found on a host OS today, e.g., an application (“Application 520”), a trust agent (“Trust Agent 525”), an 802.1X supplicant (“Supplicant 530”), a network stack, e.g., Transmission Control Protocol (“TCP”), User Datagram Protocol (“UDP”) and/or Dynamic Host Configuration Protocol (“DHCP”) (collectively referred to as “Network Stack 535”) and a wireless network driver (“Driver 540”).

In one embodiment, WLAN NIC 510 may include an encryption engine (“Encryption Engine 555”), a multiplexer/demultiplexer (“MUX/DeMUX 550”) and an additional security component, namely a key store (“Key Store 545”). MUX/DeMUX 550 may contain policies describing conditions by which routing decisions are made, i.e. when to route traffic to AMT 515 and/or Host OS 505. According to an embodiment of the invention, the introduction of AMT 515 and Key Store 545 into Wireless Node 500 provide the secure and isolated environment necessary to process the MAC functionality. By generating the security keys within AMT 515 and in one embodiment, storing these security keys in Key Store 545 (both of which are isolated from and inaccessible by Host OS 505), embodiments of the present invention provide for heightened security on Wireless Node 500. Although the specification thus far has referred only to storing the security keys in Key Store 545, embodiments of the invention are not so limited. In various other embodiments, the security keys may be stored in other “secure” locations that are isolated from and not accessible by Host OS 505 including but not limited to AMT 515, in a Trusted Platform Module (“TPM”) and/or in a key store on the hard drive on Wireless Node 500.

In one embodiment, AMT 515 may assert exclusive control over the establishment and update of MUX/DeMUX policies to further enhance the security on Wireless Host 500. As illustrated, AMT 515 may include various components including EAP-Methods 560, a 1X authenticator (“Authenticator 565”), Network Stack 570, an 802.1X Supplicant (“Supplicant 575”) and a wireless network driver (“Driver 580”). Wireless Node 500 may additionally include a switch coupling the various components to each other, as illustrated conceptually by Switch 585.

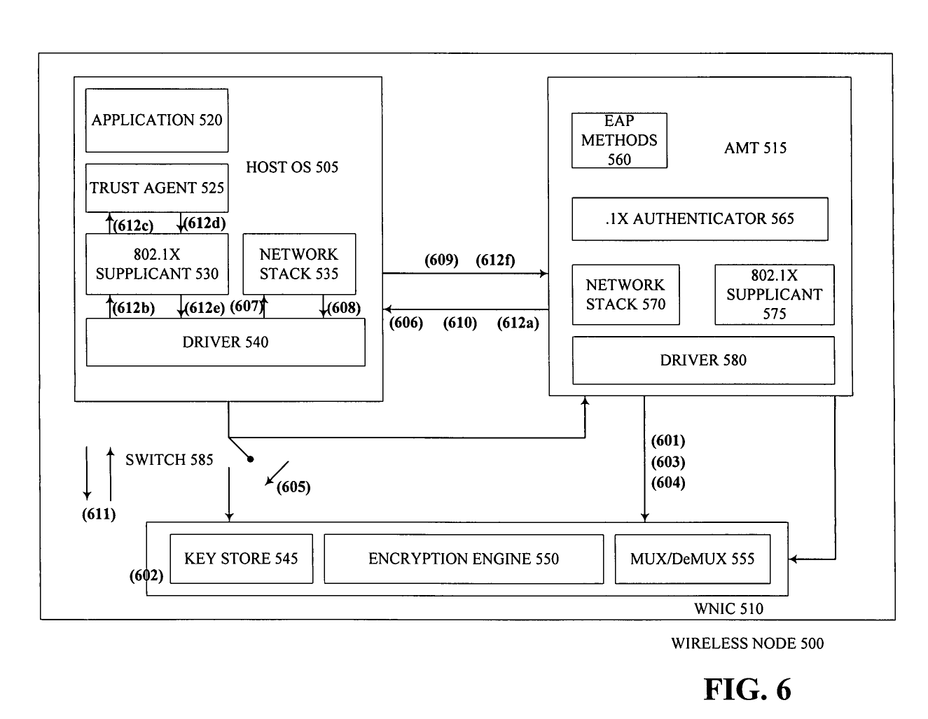

The following section expands on how the various components described above interact with each other to enable embodiments of the present invention. To facilitate understanding, FIG. 6 reiterates the elements previously introduced in FIG. 5, including arrows to illustrate the various interactions. Thus, in one embodiment, in 601, during initialization of Wireless Node 500, AMT 515 may initiate control of WNIC 510 (instead of Host OS 505 initiating control). Driver 580 in AMT 515 may perform typical 802.11 authentication procedures (e.g., scanning, discovery, and key management steps), using 802.11 control and management messages. As soon as Driver 580 recognizes a domain (i.e. recognizes a Secure System Identification, hereafter “SSID”) that Wireless Node 500 may connect to, and verifies that credentials for this SSID have been provisioned, Driver 580 may perform various 802.11i procedures for secure association with the 802.11 Access Point (“AP”), and a backend authentication server (hereafter “AAA server”) on Wireless Network 100. Thereafter, all 802.11 control and management messages between the APs are administered by Driver 580. By ensuring that Driver 580 is in control of WNIC 510, embodiments of the present invention ensure that the key generation (in AMT 515) and storage process (in Key Store 545) is isolated from Host OS 505.

In one embodiment, in 602, AMT 515 (via 802.1X Supplicant 575) may perform an 802.1X authentication exchange with the backend AAA server. More specifically, AMT 515 may derive 802.11i Pairwise Master Keys (PMK) and Pairwise Transient Keys (PTK) and install the PTK keys in the Key Store 545 Since AMT 515 controls WNIC 310 via Driver 580 and Host OS 505 has no control over WNIC 310, Key Store 545 may be completely isolated from Host OS 505. The PTK keys in the key store may be later retrieved by Authentication Engine 550 to encrypt and/or decrypt outgoing and/or incoming wireless frames. In one embodiment, a key encryption key (“KEK”) may be used in AMT 515 to key-wrap and encrypt the PMK. Since the KEK resides in a secure location (i.e., AMT 515), it may be deemed tamper resistant and the encrypted and wrapped PMK may be stored in either AMT 515 or external to AMT 515 without compromising the security of the platform.

AMT 515 may also send a security association identifier to Driver 540 (i.e., the host 802.11 driver) using a secure tunnel between itself and Main Processor 305/405. This process enables Driver 540 to acquire and use the security association identifier whenever it transmits information to AMT 515. 802.1X Supplicant 575 may also be used to perform multiple authentications, tunneled authentications and Network Access Control (“NAC”) information exchanges prior to the computation of the PMK and PTK security keys.

In one embodiment, upon evaluation of the 802.1X exchanges described above, AMT 515 may be admitted on Wireless Network 100 in 603. Thus, for example, the AAA server on Wireless Network 100 may send an encoded message (e.g., a RADIUS encoded message) to an AP indicating the desired access. At this point, Wireless Network 100 may see a client device (i.e., AMT 515) on the wired/wireless LAN. AMT 515 may then perform Dynamic Host Configuration Protocol (DHCP) procedures with a DHCP server on Wireless Network 100 to procure an Internet Protocol (“IP”) address in 604. AMT 515 may thereafter utilize the procured IP address for all traffic originating from Wireless Node 500 and/or from AMT 515.

In one embodiment, in 605, AMT 515 may close Switch 585 to allow Host OS 505 to send/receive data traffic from WNIC 510. Driver 580 may send an indication to Driver 540 to signal closing of Switch 580 in 606 and Driver 540 may then set the state for a “link-up” condition, i.e., inform Network Stack 535 that the switch is closed. In one embodiment, in 607, Driver 540 may initiate the “link-up” procedures on Network Stack 535, which in turn may perform startup DHCP procedures to procure an IP address from the network in 608, i.e., Network Stack 535 may send a DHCP request message to Wireless Network 100. This request message may be captured in 609 by Driver 540 and re-directed to Driver 580. This prevents a second DHCP request issuing from Wireless Node 500, since AMT 515 has already requested and obtained an IP address previously in 604.

In one embodiment, in 610, AMT 515 may generate a DHCP response message to the Network Stack 535, bundling into the response the previously received IP address. This DHCP response may be sent from AMT 515 to Driver 540, which may then deliver the response to Network Stack 535. As a result of this process, Host OS 505 and AMT 515 may remain in sync and utilize the same IP address. All subsequent procedures for renewing/canceling IP addresses using DHCP may either be mediated and/or snooped by AMT 515 and/or Host OS 505 (to ensure they remain in sync).

Application 520 may thereafter transmit network packets (e.g., TCP/IP packets) to Driver 540, which in turn may forward the packets to WNIC 510 in 611 following the data path, i.e., bypassing AMT 515. All received network traffic may also follow the same path, i.e., directly to Driver 540 in Host OS 510.

In one embodiment, when an AP receives data traffic from Wireless Node 500, the AP may trigger a host NAC procedure in 612, based on some criteria, such as TCP/IP ports or addresses, and/or based on specific traffic type. In an alternate embodiment, AMT 515 may trigger this NAC procedure, using the circuit breaker filters (i.e., Switch 585) on Driver 540 and/or in WNIC 510 and/or in AMT 515.

More specifically, in one embodiment, a AAA server may download policies to AMT 515 in 612a. Based on these policies, AMT 515 may close the hardware switch if the network access is disallowed. In 612b, if an 802.1X packet is detected, regular data packet flow over the controlled port may be blocked pending completion of the 802.1X exchanges if the AAA server is suspicious of nefarious activity or finds that the host does not have the correct credentials. Alternatively the data packets may be allowed to flow in tandem with 802.1X exchanges (in 612c) while the AAA Server evaluates whether the client configuration state has changed sufficiently to warrant closing or modifying an already established (and trusted) connection. Either an AP or AMT 515 may also trigger a NAC procedure (612d, 612e and 612f) to verify the credentials of Wireless Node 500.

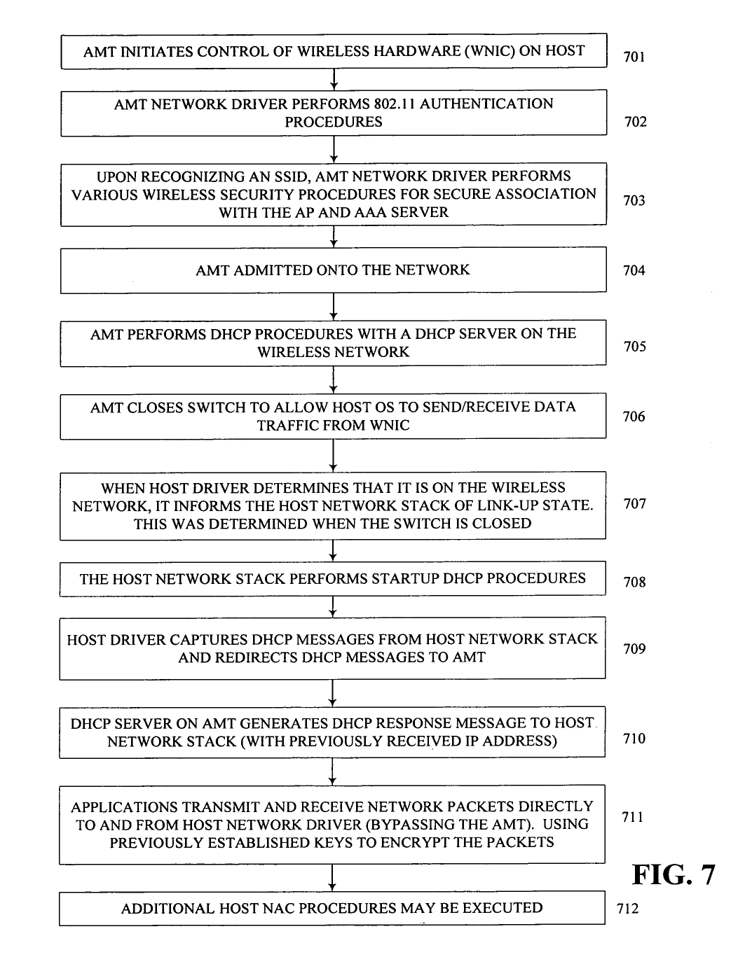

FIG. 7 is a flow chart illustrating an embodiment of the present invention. Although the following operations may be described as a sequential process, many of the operations may in fact be performed in parallel and/or concurrently. In addition, the order of the operations may be re-arranged without departing from the spirit of embodiments of the invention. In 701, during initialization of a wireless node, an AMT may initiate control of the wireless network hardware (WNIC) on the host. In 702, a wireless network driver in the AMT may perform typical 802.11 authentication procedures (e.g., scanning, discovery, and key management steps), using 802.11 control and management messages. As soon as the driver recognizes an SSID that the node may connect to, and verifies that credentials for this SSID have been provisioned, in 703, the driver may perform various 802.11 (e.g., 802.11i, 802.11r, etc.) and other security procedures for secure association with the AP and a AAA server on the wireless network. The AMT may thus be admitted on the wireless network in 704 (i.e., the wireless node is recognized on the wireless network) and in 705, the AMT may perform DHCP procedures with a DHCP server on the wireless network to procure an IP address.

In 706, the AMT may close a switch to allow the host OS to send/receive data traffic from the WNIC. When the host network driver determines that the host is on the wireless network, it may inform the host network stack in 707 that the switch is closed, and enable the host network stack to perform link-up procedures. In one embodiment, in 708, the host network stack may perform startup DHCP procedures to procure an IP address from the network. This request message may be captured in 709 by the host driver and redirected to the AMT via the AMT network driver to prevent a second DHCP request issuing from the same wireless device. The AMT may then act as a DHCP “server” to the host network stack and generate a DHCP response message in 710 to the host network stack, bundling into the response the previously received IP address.

Applications on the host may thereafter transmit network packets (e.g., TCP/IP packets) to the host network driver in 711 utilizing the IP address received from the AMT, and the host network driver may in turn forward the packets directly to the WNIC, bypassing the AMT. All received network traffic may also follow the same path, i.e., directly to the host driver. The hardware WNIC may also perform encryption procedures, using security keys established previously. In one embodiment, in 712, an AP or the AMT may additionally trigger host NAC procedures to verify the credentials of the wireless device and thereafter, all 802.11 data traffic will flow through the host driver.

The Wireless Nodes and/or APs according to embodiments of the present invention may be implemented on a variety of computing devices. According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such existing and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
routing wireless management frames received by a wireless node to a dedicated partition on the wireless node;
generating security keys in the dedicated partition;
establishing a secure link between the dedicated partition and a wireless network interface card (“WNIC”) on the wireless node; and
storing the security keys in a.location inaccessible by a host operating system on the wireless node.

2. The method according to claim 1 wherein the location comprises a key store on the wireless node.

3. The method according to claim 2 wherein the key store resides in one of the WNIC, the dedicated partition, a trusted platform module (“TPM”) and a hard disk on the wireless node.

4. The method according to claim 2 wherein the security keys comprise a Pairwise Master Key (“PMK”) and a Pairwise Transient Key (“PTK”).

5. The method according to claim 4 wherein a key encryption key (“KEK”) in the dedicated partition is used to securely encrypt the PMK.

6. The method according to claim 5 wherein the PTK is stored in the key store.

7. The method according to claim 1 further comprising:
closing a switch between the host operating system and the WNIC to establish a direct connection between the host operating system and the WNIC; and
opening the switch between the host operating system and the WNIC to disconnect the host operating system from the WNIC.

8. The method according to claim 7 further comprising:
routing wireless data frames received by the wireless node directly to the WNIC when the switch is closed.

9. The method according to claim 1 wherein the wireless management frames include wireless control frames.

10. The method according to claim 1 wherein the dedicated partition is one of an Active Management Technologies (“AMT”) partition, a Manageability Engine (“ME”) partition, a Platform Resource Layer (“PRL”) platform and a virtual machine (“VM”).

11. The method according to claim 10 wherein the AMT partition is a virtualized partition.

12. The method according to claim 1 wherein the wireless node includes a main processor and a dedicated processor and the dedicated processor is dedicated to the dedicated partition.

13. A wireless node, comprising:
a host partition running a host operating system and an application;
a dedicated partition capable of generating wireless security keys;
a wireless network interface card (“WNIC”); and
a key store for storing the wireless security keys, the key store being inaccessible from the host operating system.

14. The wireless node according to claim 13 further comprising:
a Trusted Platform Module (“TPM”); and
a hard disk, and wherein the key store resides in one of the WNIC, the dedicated partition, the TPM and the hard disk.

15. The wireless node according to claim 13 wherein the wireless security keys include a Pairwise Master Key (“PMK”) and a Pairwise Transient Key (“PTK”).

16. The wireless node according to claim 13 wherein the dedicated partition includes a key encryption key (“KEK”) used to securely encrypt the PMK.

17. The wireless node according to claim 13 wherein the dedicated partition is capable of establishing a secure link with the WNIC.

18. The wireless node according to claim 13 wherein wireless management frames received by the wireless node are routed to the dedicated partition.

19. The wireless node according to claim 18 wherein the wireless management frames include wireless control frames.

20. The wireless node according to claim 13 further comprising:
a switch capable of closing to establish a direct connecting between the host operating system in the host partition and the WNIC, the switch further capable of opening to disconnect the host operating system in the host partition from the WNIC.

21. The wireless node according to claim 20 wherein data frames generated by the application in the host partition and data frames received by the wireless node are routed directly to the WNIC when the switch is closed.

22. The wireless node according to claim 13 wherein the dedicated partition is one of an Active Management Technologies (“AMT”) partition, a Manageability Engine (“ME”) partition, a Platform Resource Layer (“PRL”) platform and a virtual machine (“VM”).

23. The wireless node according to claim 22 wherein the AMT partition is a VM running in a virtualized environment.

24. The wireless node according to claim 13 further comprising:
a main processor; and
a dedicated processor dedicated to the dedicated partition.

25. An article comprising a machine-accessible medium having stored thereon instructions that, when executed by a machine, cause the machine to:
route wireless management frames received by a wireless node to a dedicated partition on the wireless node;
generate secure keys in the dedicated partition;
establish a secure link between the dedicated partition and a wireless network interface card (“WNIC”) on the wireless node; and
store the secure keys in location inaccessible by a host operating system on the wireless node.

26. The article according to claim 25 wherein the instructions, when executed by the machine, further cause a switch to one of close to connect the host operating system directly to the WNIC and open to disconnect the host operating system from the WNIC.

27. The article according to claim 26 wherein the instructions, when executed by the machine, further cause the machine to route wireless data frames received by the wireless node directly to the WNIC when the switch is closed.

28. The article according to claim 25 wherein the dedicated partition is one of an Active Management Technologies (“AMT”) partition, a Manageability Engine (“ME”) partition, a Platform Resource Layer (“PRL”) platform and a virtual machine (“VM”).

29. The article according to claim 28 wherein the AMT partition is a VM running in a virtualized environment.

30. The article according to claim 25 wherein the wireless node includes a main processor and a dedicated processor and the instructions, when executed by the machine, further cause the dedicated processor to be dedicated to the dedicated partition.
